(19) United States
(12) Patent Application Publication
(10) Pub. No.: US 2024/0340903 A1
(43) Pub. Date: Oct. 10, 2024

(54) UPLINK CONTROL SIGNALING INDICATING CONFIGURED GRANT GROUP SWITCHING AND CONFIGURED GRANT SKIPPING

(71) Applicant: QUALCOMM Incorporated, San Diego, CA (US)

(72) Inventors: Diana MAAMARI, San Diego, CA (US); Iyab Issam SAKHNINI, San Diego, CA (US); Ahmed ELSHAFIE, San Diego, CA (US); Huilin XU, Temecula, CA (US); Linhai HE, San Diego, CA (US); Mickael MONDET, Louannec (FR)

(21) Appl. No.: 18/296,234

(22) Filed: Apr. 5, 2023

(51) Int. Cl. H04W 72/21; H04W 72/12

(52) U.S. Cl. CPC H04W 72/21; H04W 72/12

(57) ABSTRACT

Methods, systems, and devices for wireless communications are described. The described techniques provide for a user equipment (UE) to indicate both configured grant (CG) skipping and CG group switching information in a single uplink control message. For example, a network entity may indicate one or more behaviors (e.g., a first behavior for CG skipping, a second behavior for CG group switching from a first CG group to a second CG group, etc.). The UE may transmit, to the network entity, a single uplink control message including a single indicator which can refer to the first behavior, or the second behavior (e.g., and may refer to switching from any CG group to another CG group).

### FIELD OF TECHNOLOGY

The present disclosure relates to wireless communications, including uplink control signaling indicating configured grant group switching and configured grant skipping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support uplink control signaling indicating configured grant (CG) group switching and CG skipping. For example, the described techniques provide for a user equipment (UE) to indicate both CG skipping and CG group switching information. A UE may transmit an uplink control message corresponding to multiple behaviors (e.g., a first behavior for CG skipping, a second behavior for CG group switching from a first CG group to a second CG group, etc.). The UE may transmit, to the network entity, a single uplink control message including a single indicator which can refer to the first behavior, or the second behavior (e.g., and may refer to switching from any CG group to another CG group of multiple CG groups). For example, if the UE supports uplink communication via multiple CG groups, the UE may indicate in the uplink control message that it will skip PUSCH resources for a duration, or that it will switch to one of the multiple CG groups for transmissions (e.g., for a duration). In some examples, after the duration, the UE may revert to transmitting uplink signaling using a default CG group.

A method for wireless communications at a user equipment (UE) is described. The method may include transmitting an uplink control message including an indicator corresponding to a set of multiple behaviors associated with the uplink control message, where a first behavior of the set of multiple behaviors includes configured grant occasion skipping corresponding to skipping at least one configured grant occasion in at least one configured grant period, and a second behavior of the set of multiple behaviors includes configured grant group switching corresponding to switching from a first configured grant group to a second configured grant group and transmitting uplink signaling via one or more configured grant occasions in accordance with the indicator.

An apparatus for wireless communications at a UE is described. The apparatus may include a processor, memory coupled with the processor, and instructions stored in the memory. The instructions may be executable by the processor to cause the apparatus to transmit an uplink control message including an indicator corresponding to a set of multiple behaviors associated with the uplink control message, where a first behavior of the set of multiple behaviors includes configured grant occasion skipping corresponding to skipping at least one configured grant occasion in at least one configured grant period, and a second behavior of the set of multiple behaviors includes configured grant group switching corresponding to switching from a first configured grant group to a second configured grant group and transmit uplink signaling via one or more configured grant occasions in accordance with the indicator.

Another apparatus for wireless communications at a UE is described. The apparatus may include means for transmitting an uplink control message including an indicator corresponding to a set of multiple behaviors associated with the uplink control message, where a first behavior of the set of multiple behaviors includes configured grant occasion skipping corresponding to skipping at least one configured grant occasion in at least one configured grant period, and a second behavior of the set of multiple behaviors includes configured grant group switching corresponding to switching from a first configured grant group to a second configured grant group and means for transmitting uplink signaling via one or more configured grant occasions in accordance with the indicator.

A non-transitory computer-readable medium storing code for wireless communications at a UE is described. The code may include instructions executable by a processor to transmit an uplink control message including an indicator corresponding to a set of multiple behaviors associated with the uplink control message, where a first behavior of the set of multiple behaviors includes configured grant occasion skipping corresponding to skipping at least one configured grant occasion in at least one configured grant period, and a second behavior of the set of multiple behaviors includes configured grant group switching corresponding to switching from a first configured grant group to a second configured grant group and transmit uplink signaling via one or more configured grant occasions in accordance with the indicator.

Some examples of the method, apparatuses, and non-transitory computer-readable medium described herein may further include operations, features, means, or instructions for receiving radio resource control signaling enabling the configured grant occasion skipping, the configured grant group switching, or both, where transmitting the uplink control message including the indicator may be based on receiving the radio resource control signaling enabling the configured grant occasion skipping, the configured grant group switching, or both.

In some examples of the method, apparatuses, and non-transitory computer-readable medium described herein, transmitting the uplink signaling may include operations, features, means, or instructions for transmitting the uplink signaling via the one or more configured grant occasions of the second configured grant group, where the indicator corresponds to the second behavior.

In some examples of the method, apparatuses, and non-transitory computer-readable medium described herein, transmitting the uplink signaling may include operations, features, means, or instructions for transmitting the uplink signaling via the one or more configured grant occasions after skipping one or more previous configured grant occasions of the first configured grant group, where the indicator corresponds to the first behavior.

Some examples of the method, apparatuses, and non-transitory computer-readable medium described herein may further include operations, features, means, or instructions for receiving control signaling indicating that the first configured grant group includes a default configured grant group, switching, according to the second behavior, from the first configured grant group to the second configured grant group, where transmitting the uplink signaling includes transmitting the uplink signaling via the one or more configured grant occasions of the second configured grant group, and switching, according to the control signaling indicating that the first configured grant group includes the default configured grant group, to the first configured grant group from the second configured grant group, upon expiration of a timer.

Some examples of the method, apparatuses, and non-transitory computer-readable medium described herein may further include operations, features, means, or instructions for receiving control signaling including an indication of the timer, where switching to the first configured grant group from the second configured grant group upon expiration of the timer may be based on the indication of the timer.

Some examples of the method, apparatuses, and non-transitory computer-readable medium described herein may further include operations, features, means, or instructions for receiving, via control signaling, an indication of a set of multiple sets of configured grant groups, where each set of configured grant groups includes one or more configured grant groups for transmitting uplink signaling and one or more configured grant groups for skipping.

A method for wireless communications at a network entity is described. The method may include receiving an uplink control message including an indicator corresponding to a set of multiple behaviors associated with the uplink control message, where a first behavior of the set of multiple behaviors includes configured grant occasion skipping corresponding to skipping at least one configured grant occasion in at least one configured grant period, and a second behavior of the set of multiple behaviors includes configured grant group switching corresponding to switching from a first configured grant group to a second configured grant group and receiving uplink signaling via one or more configured grant occasions in accordance with the indicator.

An apparatus for wireless communications at a network entity is described. The apparatus may include a processor, memory coupled with the processor, and instructions stored in the memory. The instructions may be executable by the processor to cause the apparatus to receive an uplink control message including an indicator corresponding to a set of multiple behaviors associated with the uplink control message, where a first behavior of the set of multiple behaviors includes configured grant occasion skipping corresponding to skipping at least one configured grant occasion in at least one configured grant period, and a second behavior of the set of multiple behaviors includes configured grant group switching corresponding to switching from a first configured grant group to a second configured grant group and receive uplink signaling via one or more configured grant occasions in accordance with the indicator.

Another apparatus for wireless communications at a network entity is described. The apparatus may include means for receiving an uplink control message including an indicator corresponding to a set of multiple behaviors associated with the uplink control message, where a first behavior of the set of multiple behaviors includes configured grant occasion skipping corresponding to skipping at least one configured grant occasion in at least one configured grant period, and a second behavior of the set of multiple behaviors includes configured grant group switching corresponding to switching from a first configured grant group to a second configured grant group and means for receiving uplink signaling via one or more configured grant occasions in accordance with the indicator.

A non-transitory computer-readable medium storing code for wireless communications at a network entity is described. The code may include instructions executable by a processor to receive an uplink control message including an indicator corresponding to a set of multiple behaviors associated with the uplink control message, where a first behavior of the set of multiple behaviors includes configured grant occasion skipping corresponding to skipping at least one configured grant occasion in at least one configured grant period, and a second behavior of the set of multiple behaviors includes configured grant group switching corresponding to switching from a first configured grant group to a second configured grant group and receive uplink signaling via one or more configured grant occasions in accordance with the indicator.

### BRIEF DESCRIPTION OF THE DRAWINGS

FIG. 1 shows an example of a wireless communications system that supports uplink control signaling indicating configured grant (CG) group switching and CG skipping in accordance with one or more aspects of the present disclosure.

FIG. 2 shows an example of a wireless communications system that supports uplink control signaling indicating CG group switching and CG skipping in accordance with one or more aspects of the present disclosure.

FIG. 3 shows an example of a configured uplink transmission scheme that supports uplink control signaling indicating CG group switching and CG skipping in accordance with one or more aspects of the present disclosure.

FIG. 4 shows an example of a configured uplink transmission scheme that supports uplink control signaling indicating CG group switching and CG skipping in accordance with one or more aspects of the present disclosure.

FIG. 5 shows an example of a process flow that supports uplink control signaling indicating CG group switching and CG skipping in accordance with one or more aspects of the present disclosure.

FIGS. 6 and 7 show block diagrams of devices that support uplink control signaling indicating CG group switching and CG skipping in accordance with one or more aspects of the present disclosure.

FIG. 8 shows a block diagram of a communications manager that supports uplink control signaling indicating CG group switching and CG skipping in accordance with one or more aspects of the present disclosure.

FIG. 9 shows a diagram of a system including a device that supports uplink control signaling indicating CG group switching and CG skipping in accordance with one or more aspects of the present disclosure.

FIGS. 10 and 11 show block diagrams of devices that support uplink control signaling indicating CG group switching and CG skipping in accordance with one or more aspects of the present disclosure.

FIG. 12 shows a block diagram of a communications manager that supports uplink control signaling indicating CG group switching and CG skipping in accordance with one or more aspects of the present disclosure.

FIG. 13 shows a diagram of a system including a device that supports uplink control signaling indicating CG group switching and CG skipping in accordance with one or more aspects of the present disclosure.

FIGS. 14 through 17 show flowcharts illustrating methods that support uplink control signaling indicating CG group switching and CG skipping in accordance with one or more aspects of the present disclosure.

### DETAILED DESCRIPTION

In some wireless communications systems, a network entity may schedule uplink signaling via multiple periodic or aperiodic uplink resources. For example, the network entity may schedule a user equipment (UE) with one or more configured grants (CGs), or CG groups (e.g., or CG sets). For example, a CG may refer to a configuration of multiple resources within a given period, which are scheduled to be available for uplink transmissions by the UE. In some examples, a CG group may refer to multiple periods of a given CG. Each group of CGs may include a quantity of resources (periodic CG occasions) for the UE to transmit pending uplink communications (e.g., via physical uplink shared channel (PUSCH) resources). Different CG groups may include CG occasions (e.g., PUSCH occasions) having different periodicities and densities (e.g., different CG groups may include different quantities of CG occasions within a same time window). In some cases, the UE may not have sufficient uplink traffic to utilize all CG occasions of a given CG group. In such cases, the UE may indicate, in an uplink control information (UCI) message, a quantity of CG occasions to be skipped or a duration during which the UE will skip all CG occasions, so that the resources (e.g., the PUSCH resources) may be reallocated by the network (e.g., instead of remaining unoccupied).

In some examples, the network entity may indicate that the UE is permitted to use multiple CG groups which have varying periodicities of CG occasions (e.g., with more or less CG occasions per CG period). The network entity may indicate, via a downlink control information (DCI), one of the CG groups for the UE to use (e.g., to switch from one CG group to another CG group). However, the UE may have more access to information, or more accurate information (e.g., a size of an uplink transmission) regarding which CG group the UE should use given an amount of pending uplink traffic. The UE may therefore more accurately determine a CG group with an appropriate quantity of PUSCH resources for pending uplink transmissions. Additionally, if the UE transmits one indication for CG skipping, and separate signaling indicates CG group switching, such techniques may result in increased signaling overhead, less efficient use of available system resources, increased system latency, and decreased user experience.

Accordingly, techniques described herein may allow for the UE to transmit control signaling indicating both CG group switching and CG occasion skipping information. For example, the UE may indicate, in an uplink control message (e.g., a UCI, or a medium access control (MAC) control element (CE), among other examples), both CG occasion skipping and CG group switching information. CG skipping may also be referred to herein as CG occasion skipping, and may refer to herein of skipping a quantity of CG occasions. For example, the network entity may enable (e.g., via high layer radio resource control (RRC) signaling) one or more behaviors (e.g., a first behavior for CG occasion skipping, a second behavior for CG group switching from a first CG group to a second CG group, etc.). The UE may transmit, to the network entity, a single uplink control message, where the uplink control message includes a single indicator which can refer to the first behavior, or the second behavior (e.g., and may refer to switching from any CG group to another CG group). For example, if the UE is permitted to use multiple CG groups, the UE may indicate (e.g., via a first codepoint of the uplink control message) that it will skip PUSCH resources for a duration, or (e.g., via a second codepoint of the uplink control message) that it will switch to one of the multiple CG groups for transmissions (e.g., for a duration). In some examples, after the duration, the UE may revert to transmitting uplink signaling using a default CG group.

Aspects of the disclosure are initially described in the context of wireless communications systems. Aspects of the disclosure are further illustrated by and described with respect to configured uplink transmission schemes and process flow diagrams. Aspects of the disclosure are further illustrated by and described with reference to apparatus diagrams, system diagrams, and flowcharts that relate to uplink control signaling indicating CG group switching and CG occasion skipping.

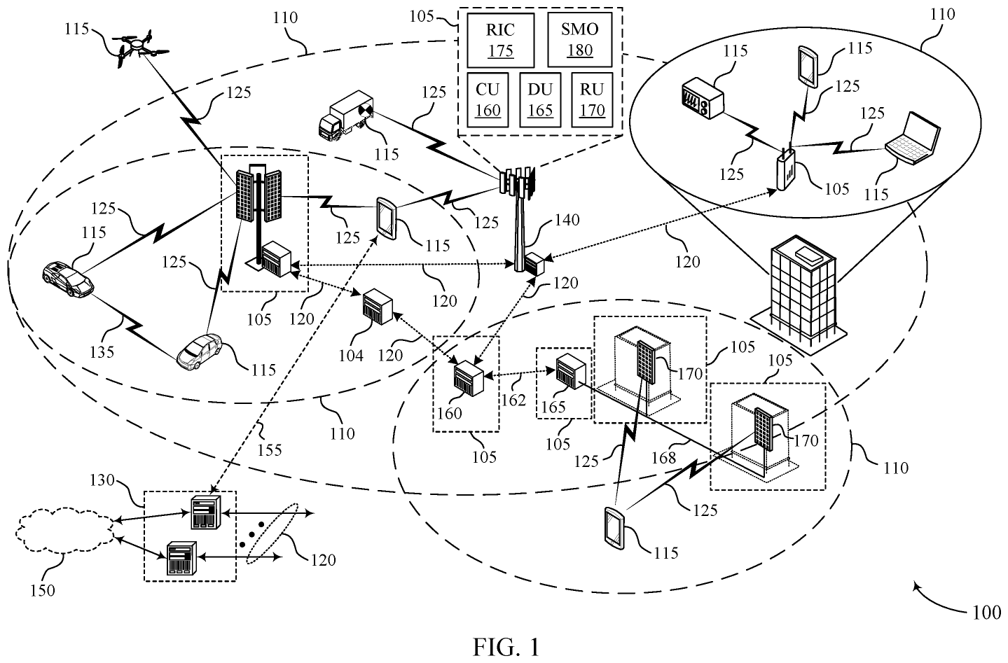

FIG. 1 shows an example of a wireless communications system 100 that supports uplink control signaling indicating CG group switching and CG skipping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink control signaling indicating CG group switching and CG skipping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The described techniques provide for a UE 115 to indicate both CG skipping and CG group switching information. For example, a network entity 105 may indicate one or more behaviors (e.g., a first behavior for CG skipping, a second behavior for CG group switching from a first CG group to a second CG group, etc.). The UE 115 may transmit, to the network entity 105, a single uplink control message including a single indicator which can refer to the first behavior, or the second behavior (e.g., and may refer to switching from any CG group to another CG group). For example, the UE 115 may indicate in the uplink control message that it will skip CG occasions (e.g., PUSCH resources) for a duration, or that it will switch to one of the multiple CG groups for transmissions (e.g., for a duration). In some examples, after the duration, the UE 115 may revert to transmitting uplink signaling via CG occasions of a default CG group.

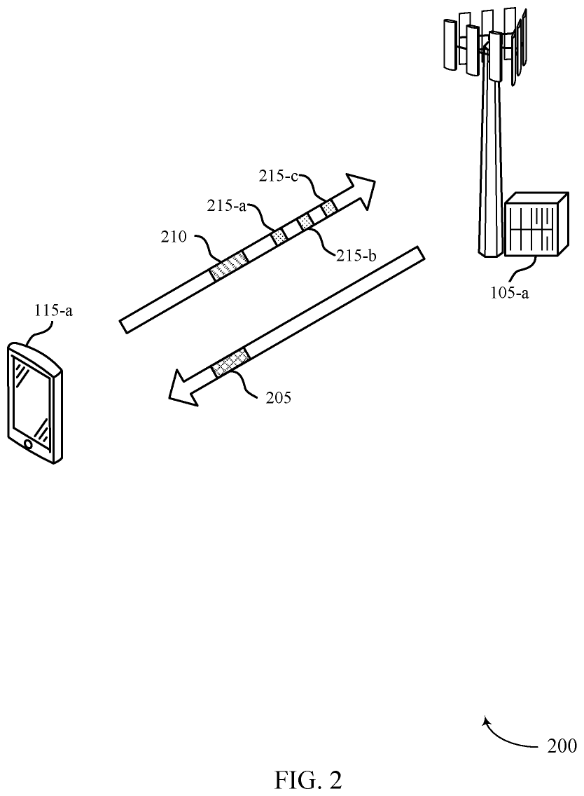

FIG. 2 shows an example of a wireless communications system 200 that supports uplink control signaling indicating CG group switching and CG skipping in accordance with one or more aspects of the present disclosure. The wireless communications system 200 may implement aspects of or may be implemented by aspects of the wireless communications system 100. For example, the wireless communications system 200 may include a UE 115 (e.g., a UE 115-a) and a network entity 105 (e.g., a network entity 105-a), which may be examples of corresponding devices as described with reference to FIG. 1.

In some wireless communications systems, the network entity 105-a may indicate (e.g., via control signaling) uplink resources for transmitting uplink signaling. Such scenarios may be referred to as CGs, or semi-persistent scheduling, among other examples. For example, the network entity 105-a may transmit control signaling to the UE 115-a indicating one or more CG groups. Each CG group may include a quantity of resources (e.g., periodic CG occasions 215, or aperiodic CG occasions 215) for the UE 115-a to use to transmit uplink communications (e.g., CG occasions 215 may be located in one or more PUSCHs). Different CG groups may include CG occasions 215 having different periodicities and densities (e.g., different CG groups may include different quantities of CG occasions 215 per CG period). As described herein, a CG group may refer to any configuration of granted resources (e.g., resources granted to a UE by the network for uplink signaling). For example, the network entity 105-a may configure the UE 115-a with one or more groups SPS occasions, or SPS sets. Techniques described herein with reference to CG group switching and CG skipping may refer to any configured resources for uplink signaling, such as CG groups, or SPS resources or sets of configured resources, among other examples. For example, as described herein, techniques for switching from a first CG group to a second CG group may be similar applied for switching from a first SPS configuration to a second SPS configuration. For example, the techniques discussed herein may be similar used for SPS set switching, SPS skipping, or both.

In some cases, the UE 115-a may support CG occasion skipping. In such examples, the UE 115-a may be configured with a set of CG occasions 215, but may not have sufficient uplink traffic pending to utilize all CG occasions 215 of a given CG group. In such cases, the UE 115-a may indicate, in an uplink control information (UCI) message, a quantity of CG occasions 215 to be skipped or a duration during which the UE 115-a will skip all CG occasions 215, so that the resources may be reallocated. For instance, such a UCI message (e.g., the control message 210) may carry an indication that the UE 115-a will not transmit uplink signaling via one or more of the CG occasion 215-a, the CG 215-b, and the CG occasion 215-c.

In some examples, the network entity 105-a may instruct the UE 115-a to perform CG group switching. For example, the network entity 105-a may configure the UE 115-a with multiple CG groups which have varying periodicities of CG occasions 215 (e.g., with more or less CG occasions 215 per CG period). The network entity 105-a may indicate, via a DCI, one of the CG groups for the UE 115-a to use (e.g., to switch from one CG group to another CG group). For instance, the network entity 105-a may indicate that the UE 115-a is to switch from a first CG group having a first CG occasion density (e.g., more CG occasions 215 within a period) to a second CG group having a second CG occasion density (e.g., less CG occasions 215 within the period of more CG occasions 215 within the period than the first CG group). Such CG group switching may provide more flexibility for uplink transmissions. However, the UE 115-a may have access to more information (e.g., may be more able to identify a size of an uplink transmission) regarding which CG group the UE 115-a should use given an amount of pending uplink traffic, and therefore may more accurately determine a CG group with an appropriate quantity of PUSCH resources (e.g., CG occasions 215) for the pending uplink traffic. Additionally, if the UE 115-a transmits first signaling indicating CG occasion skipping and separate signaling indicating CG group switching, such techniques may result in increased signaling overhead and increased latency.

Accordingly, techniques described herein may support the UE 115-a transmitting joint uplink control signaling indicating both CG skipping and CG group switching. The UE 115-a may indicate, in a UCI (e.g., or a medium access control (MAC) control element (CE)), both CG skipping and CG group switching information. For example, the network entity 105-a may indicate (e.g., via high layer radio resource control (RRC) signaling 205) one or more behaviors (e.g., a first behavior for CG skipping, a second behavior for CG group switching from a first CG group to a second CG group, etc.). The UE 115-a may transmit, to the network entity 105-a, a single uplink control message 210 including a single indicator which can refer to the first behavior or the second behavior (e.g., and may refer to switching from any CG group to any other CG group). For example, if the UE 115-a is permitted to use multiple CG groups, the UE 115-a may indicate in the uplink control message 210 that it will skip PUSCH resources for a duration, or that it will switch to one of the multiple CG groups for transmissions via the CG occasions 215 (e.g., for a duration).

In some examples, the network entity 105-a may indicate (e.g., via RRC signaling 205) if one or both of CG skipping and CG group switching are enabled. The RRC signaling 205 may include multiple RRC messages. In some examples (e.g., if both CG skipping and CG group switching are enabled via higher layer configuration, such as RRC), the indicator in the uplink control message 210 may include a quantity of bits (e.g., two bits) indicating one of multiple CG skipping and CG group switching behaviors. In some examples, the UE 115-a may transmit or receive an indication of CG skipping that applies to an active (e.g., current) CG group. In some examples, the multi-bit indicator (e.g., two bit indicator) may be used to indicate CG group switching, or may be shared between CG group switching and CG occasion skipping. Such a joint indicator may be based on one or more (e.g., two) higher layer configurations enabling both CG group switching and CG skipping. In such examples, when a UE sends or receives an indication for CG skipping, the indicator may apply to an active (e.g., a current) CG group.

If, for example, CG skipping is enabled and CG group switching is not enabled (e.g., as indicated via one or more RRC messages, such as the RRC signaling 205), the indicator in the uplink control message 210 may include a quantity of bits (e.g., one or two bits) indicating one or more durations (e.g., a time, a quantity of occasions, a bitmap, etc.) during which the UE 115-a may skip transmitting on CG occasions 215.

In some examples, if the UE 115-a is enabled to perform CG group switching, the indicator in the uplink control message 210 may indicate that the UE 115-a will switch from a first CG group to a second CG group. In some examples, after a duration, the UE 115-a may revert to transmitting using the first (e.g., default) CG group. That is, the UE 115-a may transmit according to a first CG group until the UE 115-a transmits an indication of switching to a second CG group. The UE 115-a may switch to transmitting according to the second CG group for the duration (e.g., until a timer expires). After the duration (e.g., upon the expiration of the timer), the UE 115-a may switch to transmitting according to the first CG group.

In some examples, the first CG group and the second CG group may correspond to different component carriers. In such examples, the UE 115-a may indicate a first codepoint corresponding to the first CG group (e.g., and the first component carrier) or a second codepoint corresponding to the second CG group (e.g., and the second component carrier). In some examples, a codepoint of the indicator may indicate cross component carrier CG group switching (e.g., a codepoint may indicate that the UE 115-a is to switch from a first CG group on a first component carrier to a second CG group on a second component carrier).

In some examples, the CG group switching in the indicator may be a request (e.g., a suggestion) and the network entity 105-a may determine if the UE 115-a may perform CG group switching. That is, the UE 115-a may transmit the indicator requesting a CG group for the UE 115-a to switch to, and the network entity 105-a may transmit (e.g., via a DCI) an indication of a CG group for the UE 115-a to use (e.g., based on the request).

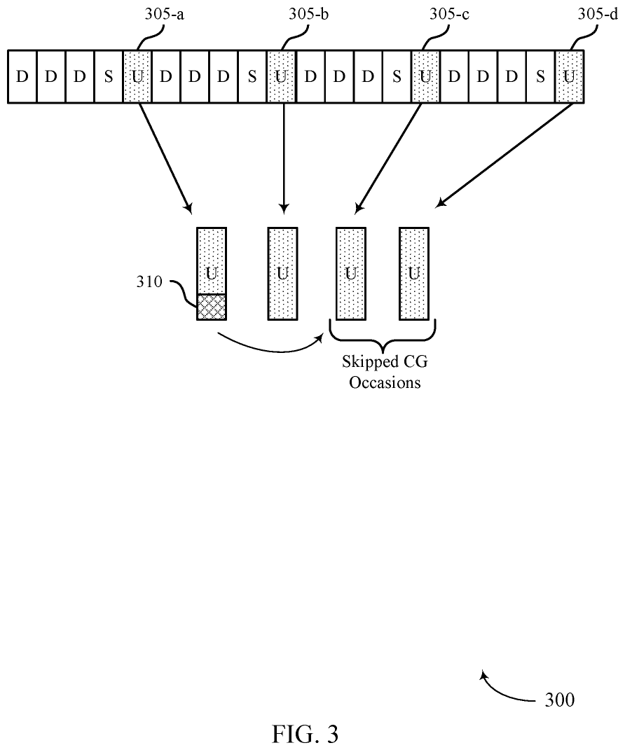

FIG. 3 shows an example of a configured uplink transmission scheme 300 that supports uplink control signaling indicating CG group switching and CG skipping in accordance with one or more aspects of the present disclosure. The configured uplink transmission scheme 300 may implement aspects of or may be implemented by aspects of the wireless communications system 100 or the wireless communications system 200. For example, the configured uplink transmission scheme 300 may be implemented by a UE 115 and a network entity 105, which may be examples of the corresponding devices as described with reference to FIG. 1 and FIG. 2.

The network entity 105 may configure the UE 115 with one or more CG occasions 305 (e.g., in one or more CG groups). The network entity 105 may further configure the UE 115 with a transmission pattern including one or more uplink (e.g., U) slots, one or more downlink (e.g., D) slots, one or more flexible or special (S) slots, or a combination thereof. For instance, the UE 115 may be configured with a repeating pattern, such as DDDSU. In some examples, a CG group may include one or more slots allocated to a UE 115 for uplink transmissions (e.g., one or more UE slots allocated to the UE for transmitting any pending uplink traffic, without the need for additional dynamic grants, which may increase signaling overhead). The one or more slots may include CG occasions 305 configured for uplink transmissions (e.g., PUSCH transmissions). For example, the UE 115 may receive, from a network entity 105, a configuration of a CG group with four CG occasions 305 (e.g., a CG occasion 305-a, a CG occasion 305-b, a CG occasion 305-c, and a CG occasion 305-d). The UE may utilize the CG occasions 305 for transmitting pending uplink traffic. The CG group may support multiple CG PUSCH transmission occasions in a period of a single CG PUSCH configuration.

In some examples, to avoid resource waste, the UE 115 and the network entity may support a mechanism for reallocating unused CG resources within a given CG period. The UE 115 may support a dynamic indication of unused CG PUSCH occasions (e.g., CG occasions 305) based on a UCI message (e.g., a CG-UCI, or another UCI). The UE 115 may determine a quantity of CG occasions 305 needed for a transmission (e.g., one or more video frames for uplink extended reality (XR)). That is, based on a size of the transmission (e.g., a video frame size of the video frame), the UE 115 may determine a quantity or duration of CG occasions 305 needed for the transmission. Therefore, to avoid wasted resources, the UE 115 may indicate CG occasions 305 which are not needed for the transmission to the network entity 105 so that they may be reallocated. For example, when an uplink packet (e.g., an uplink XR video frame) arrives for transmission, the UE 115 may use the video frame size to determine a quantity of PUSCH resources (e.g., a quantity of CG occasions 305) the UE 115 will use to transmit the video frame. The UE 115 may also be able to determine the size of one or more video frames for one or more subsequent resources (e.g., a second PUSCH resource or second CG occasion 305). The UE 115 may transmit, in an uplink control message 310 (e.g., a UCI or a MAC-CE), an indication of the unneeded CG occasions 305.

In the example of FIG. 3, the UE 115 may determine that, based on an amount of pending uplink traffic (e.g., a quantity or size of one or more video frames), the UE 115 has sufficient uplink data to transmit via two CG occasions 305 (e.g., the CG occasion 305-a and the CG occasion 305-b), but that the UE 115 does not have sufficient data to transmit via one or more additional CG occasions 305 (e.g., the CG occasion 305-c and the CG occasion 305-d). CG occasion 305-c and the CG occasion 305-d would therefore remain unoccupied by uplink transmissions by the UE 115, resulting in inefficient use of available system resources. In such examples, the UE 115 may transmit, via an uplink control message 310 during the CG occasion 305-a, a message (e.g., an indicator) indicating that the UE 115 may skip one or more CG occasions 305 (e.g., may skip transmitting during the CG occasion 305-c and the CG occasion 305-d). In some examples, the UE 115 may indicate a different quantity of CG occasions 305 during which the UE 115 may skip transmitting. In some examples, the UE 115 may transmit the uplink control message during a different CG occasion 305 (e.g., during the CG occasion 305-b). Based on the indication that the UE 115 will skip one or more CG occasions 305, the network entity 105-a may more efficiently utilize available system resources (e.g., may reallocate the CG occasion 305-c and the CG occasion 305-d for communications with one or more additional devices, instead of leaving the CG occasion 305-c and the CG occasion 305-d unoccupied).

In some examples, the UE 115 may skip a duration of CG occasions 305 according to the indication starting on a CG occasion 305 directly following the CG occasion 305-a carrying the uplink control message 310. That is, the UE 115 may transmit on the CG occasion 305-a and skip the CG occasion 305-b, the CG occasion 305-c, and the CG occasion 305-d. In some examples, the UE 115 may skip the duration of CG occasions 305 corresponding to the indication starting on a CG occasion 305 after a delay following the CG occasion 305-a carrying the uplink control message 310 (e.g., a preconfigured quantity of CG occasions 305 after the CG occasion 305-a carrying the uplink control message 310). That is, the UE 115 may transmit on the CG occasion 305-a and, for example, the CG occasion 305-b, and may skip the CG occasion 305-c and the CG occasion 305-d. The duration may be, for example, a preconfigured time duration or quantity of intervals (e.g., a quantity of symbols, or slots, among other examples). In some examples, the duration may be a quantity of CG occasions 305. In some examples, the duration may be one of multiple possible durations indicated from a bitmap (e.g., a bitmap configured via RRC signaling).

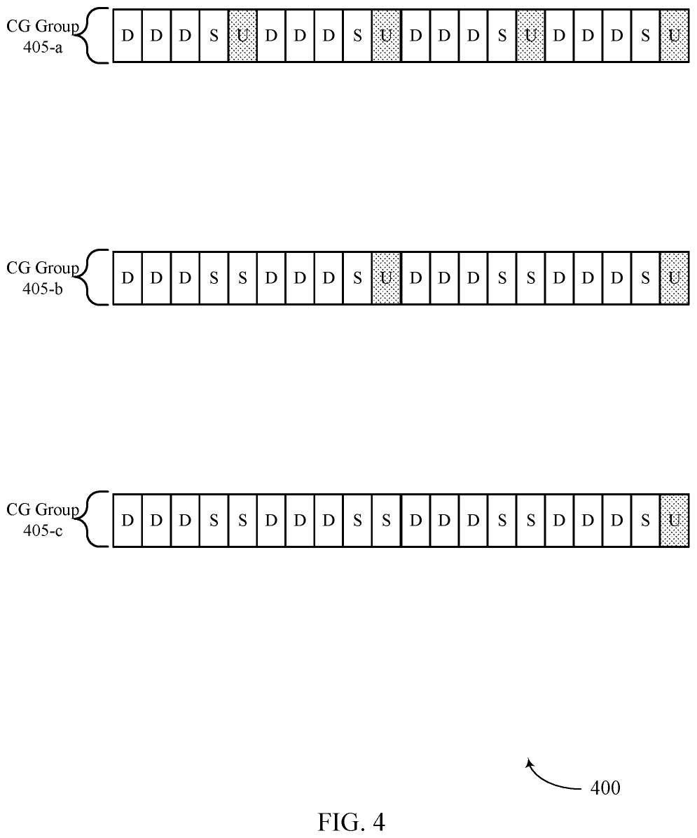

As described in greater detail with reference to FIG. 4, in some examples, the network entity 105 may configure the UE 115 with one or more CG groups (e.g., each CG group including a quantity of CG occasions 305). The network entity 105 may indicate, to the UE 115, that the UE 115 is to switch between configured CG groups. However, the UE 115, not the network entity 105, may have access to more information regarding when the UE 115 is to switch between CG groups. That is, the UE 115 may have access to information regarding whether the UE 115 has a large amount of uplink data pending for transmission (e.g., in which case a CG group with a high density or high quantity of CG occasions 305 may be appropriate), or a smaller amount of uplink data pending for transmission (e.g., in which case a CG group with a lower density or lower quantity of CG occasions 305 may be appropriate), or no uplink data pending for transmission (e.g., in which case one or all subsequent CG occasions 305 may be skipped). Without a mechanism to indicate CG group switching information, the network entity 105 may not be able to effectively configure the UE 115 to efficiently switch between CG groups. Further, separate message to indicate when the UE is to perform CG skipping, or to provide an indication of CG group switching, may result in increased signaling overhead and increased system latency.

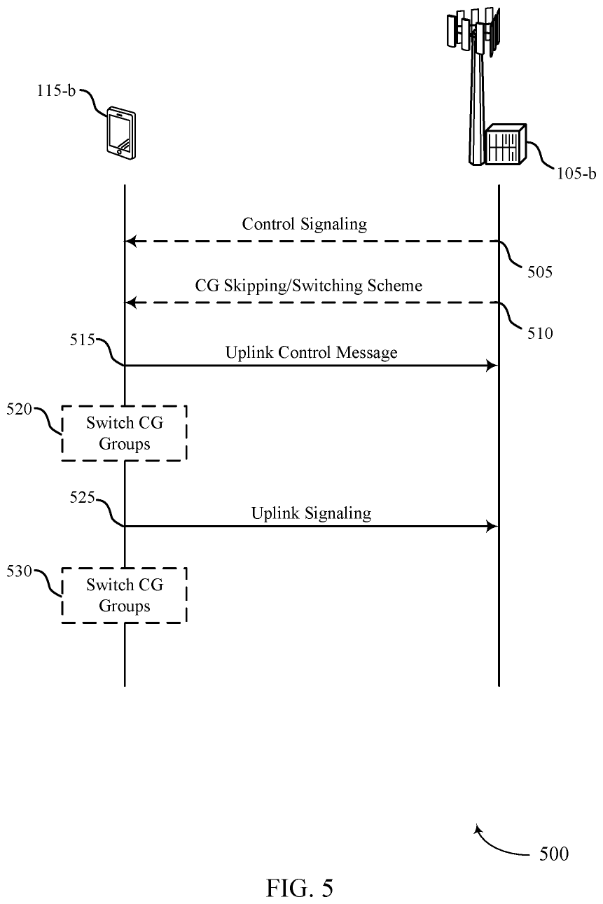

In some examples, as described herein, to allocate resources efficiently and reduce signaling overhead, the UE 115 may indicate both CG occasion skipping information and CG group switching information to the network entity 105 via a joint indicator (e.g., in an uplink control message with a unified design for CG skipping and CG group switching), which may additionally or alternatively indicate that the UE 115 will perform CG group switching or CG occasion skipping, as described with reference to FIG. 4 and FIG. 5.

FIG. 4 shows an example of a configured uplink transmission scheme 400 that supports uplink control signaling indicating CG group switching and CG skipping in accordance with one or more aspects of the present disclosure. The configured uplink transmission scheme 400 may implement aspects of or may be implemented by aspects of the wireless communications system 100 or the wireless communications system 200. For example, the configured uplink transmission scheme 400 may include a UE 115 and a network entity 105, which may be examples of the corresponding devices as described with reference to FIG. 1 and FIG. 2.

In some wireless communication systems, a network entity 105 may configure a UE 115 (e.g., via RRC signaling) with multiple CG groups 405 (e.g., a CG group 405-a, a CG group 405-b, and a CG group 405-c). The multiple CG groups 405 may have varying periodicities (e.g., frequencies) of CG occasions allocated for uplink transmissions. Each CG group may be configured with a period (e.g., a time duration), and each period may include one or more CG occasions 305. In some CG groups 405, a given slot may be allocated as a CG occasion for uplink transmissions. In some other CG groups 405, the slot may be allocated for other purposes (e.g., an uplink slot allocated for dynamic grants, or for other UEs to use for uplink signaling, a special slot or a downlink slot). Each CG group may have a different density (e.g., quantity per period) of CG occasions (e.g., CG occasions 305, as described with reference to FIG. 3). For example, the CG group 405-a may have a higher density or quantity of CG occasions (e.g., four CG occasions per period), the CG group 405-b may have a different density or quantity (e.g., a lower density) of CG occasions (e.g., two CG occasions per period), and the CG group 405-c may have a different density or quantity (e.g., a lowest density) of CG occasions (e.g., one CG occasion per period).

In some examples, the network entity 105 may indicate (e.g., in a DCI) for the UE 115 to switch from a first CG group 405 to a second CG group 405. That is, the network entity 105 may transmit a DCI which may simultaneously activate a set of one or more CG groups 405 and release a set of one or more CG groups 405. This may allow for adaptive adjustment of CG occasion density, or periodicity, for more effective resource allocation depending on channel and traffic conditions. For example, the CG occasion periodicity (e.g., the quantity of slots allocated for PUSCH transmissions) may be dynamically adjusted to reflect an encoding algorithm (e.g., a video encoding algorithm) which is adaptive to varying channel conditions, traffic, etc.

However, the UE 115 may have access to more information, or more accurate information, regarding which CG groups 405 may be more effective. For example, the UE 115 may have access to information regarding a size (e.g., a video frame size) of a transmission (e.g., a video frame). Accordingly, the UE 115 may transmit an indicator, to the network entity 105 (e.g., in an uplink control message such as a UCI or a MAC-CE), indicating one or more CG groups 405 the UE 115 may use for uplink transmissions. For example, if the transmission size is large, the UE 115 may transmit an indication of a CG group 405 with more frequent CG occasions (e.g., the CG group 405-a). In some examples, if the transmission size is smaller, the UE 115 may transmit an indication of a CG group 405 with less frequent CG occasions (e.g., the CG group 405-b or the CG group 405-c). To allocate resources efficiently and reduce signaling overhead, the indicator may additionally or alternatively indicate that the UE 115 will perform CG skipping as described with reference to FIG. 3.

For example, the indicator (e.g., the uplink control message 310) may indicate one behavior of a group of multiple possible behaviors which the UE 115 will use for subsequent uplink transmissions via CG occasions or CG groups. That is, the indicator may indicate a first UE behavior in which the UE 115 may skip CG occasions for one or more durations. The duration may be, for example, a preconfigured time or quantity of slots. Alternatively, the duration may be a quantity of CG occasions. Alternatively, the duration may be one of multiple durations indicated from a bitmap (e.g., a bitmap configured via RRC signaling).

Additionally, or alternatively, the same indicator may indicate a second UE behavior in which the UE 115 may transmit according to a set of one or more CG groups 405. In some examples, each codepoint of the indicator may correspond to a different behavior. The indicator may include, for example, two bits which collectively indicate one of four possible behaviors, as depicted below in Table 1.

TABLE 1

| | | |
|---|---|---|
| CG | Beh 1 | Skipping PUSCH occasion(s) of a CG for duration X |
| Skipping | | |
| CG Set | Beh 2 | Skipping CG group 405-b and CG group 405-c; and |
| Switching | | Transmitting with CG group 405-a |
| | Beh | Skipping CG group 405-a and CG group 405-c; and |
| | 2A | Transmitting with CG group 405-b |
| | Beh | Skipping CG group 405-a and CG group 405-b; and |
| | 2B | Transmitting with CG group 405-c |

Thus, a first codepoint may indicate that the UE 115 will skip one or more PUSCH occasions 305 (e.g., for the duration X, which may be a set amount of time, a quantity of symbols or slots, a quantity (e.g., a number) of PUSCH occasions 305, among other examples). A second codepoint may indicate that the UE 115 will switch to uplink transmissions via the PUSCH occasions of the CG group 405-a. In some examples, each CG group (e.g., the CG group 405-a) may contain one or more CG configurations. (e.g., including one or more CG configurations), and will skip any uplink transmissions according to the CG group 405-b and the CG group 405-c. A third codepoint may indicate a third behavior (e.g., behavior 2A), in which the UE 115 may skip the CG group 405-a and the CG group 405-c, and transmit according to the CG group 405-b (e.g., via the PUSCH occasions of the CG group 405-b). A fourth codepoint may indicate a fourth behavior (e.g., behavior 2B), in which the UE 115 may skip the CG group 405-a and the CG group 405-b, and may transmit via the PUSCH occasions according to the CG group 405-c. In some examples, each behavior may correspond to a set of CG groups (e.g., one or more CG groups via which the UE 115 will transmit uplink signaling, and one or more CG groups that the UE 115 will skip).

In some examples, the network entity may configure the UE with the one or more behaviors, the one or more sets of CG groups, and the indicator, and may indicate to the UE which codepoints correspond to which behaviors. For instance, the network entity may transmit control signaling (e.g., RRC signaling) indicating a lookup table (e.g., such as table 1) indicating one or more codepoints and one or more behaviors. In such examples, the UE may configure the indicator (e.g., to be transmitted via a control message 310, such as a UCI or MAC-CE) to indicate a selected behavior (e.g., based on a quantity of pending traffic, channel conditions, frame size, among other examples).

Thus, as described herein, a UE 115 may transmit a single joint indicator (e.g., via a UCI message or a MAC-CE message, among other examples) to indicate CG occasion skipping (e.g., as described with reference to FIG. 3), and CG group switching (e.g., as described with reference to FIG. 4). It is also noted that the techniques described herein may also be implemented in downlink using downlink DCI to indicate CG set switching, CG skipping, or both, as described herein.

FIG. 5 shows an example of a process flow 500 that supports uplink control signaling indicating CG group switching and CG skipping in accordance with one or more aspects of the present disclosure. The process flow 500 may implement aspects of or may be implemented by aspects of the wireless communications system 100 or the wireless communications system 200. For example, the process flow 500 may include a UE 115 (e.g., a UE 115-b) and a network entity 105 (e.g., a network entity 105-b), which may be examples of the corresponding devices as described with reference to FIG. 1.

In the following description of the process flow 500, the operations between the network entity 105-b and the UE 115-b may be transmitted in a different order than the example order shown. Some operations may also be omitted from the process flow 500, and other operations may be added to the process flow 500.

In some examples, at 505, the network entity 105-b may transmit, to the UE 115-b, first control signaling indicating whether one or more of CG skipping or CG group switching are enabled. The first control signaling may be, for example, higher layer signaling, such as an RRC message. In some examples, the first control signaling may be more than one RRC messages (e.g., one RRC message indicating whether CG skipping is enabled and one RRC message indicating whether CG group switching is enabled). The UE 115-b may perform CG group switching or CG skipping according to the first control signaling as described herein.

In some examples, at 510, the network entity 105-b may transmit, to the UE 115-b, second control signaling (e.g., RRC signaling) indicating one or more behaviors for a joint CG skipping and set switching scheme. The CG skipping and set switching scheme may indicate a first UE behavior in which the UE 115-b may skip one or more CG occasions of one or more CG groups. The CG skipping and set switching scheme may additionally indicate a second UE behavior in which the UE 115-b may switch from a first CG group to a second CG group (e.g., and skip the first CG group). In some examples, the first CG group and the second CG group may correspond to different component carriers (e.g., a second component carrier and a first component carrier, respectively).

In some examples, the second control signaling may indicate that the first CG group is a default CG group. That is, the second control signaling may indicate a duration (e.g., a timer) for the UE 115-b to perform set switching. The second control signaling may include an indication of the timer. Upon expiration of the timer, the UE 115-b may switch to the first CG group (e.g., the default CG group).

In some examples, the second control signaling may include an indication of one or more sets of CG groups. For example, each set of CG groups may include one or more CG groups which the UE 115-b may use for uplink transmissions. Each set of CG groups may additionally include one or more CG groups for the UE 115-b to skip (e.g., to refrain from using for uplink transmissions). In such examples, the UE 115-b may be configured with one or more codepoints (e.g., one or more bits) corresponding to the one or more behavior and the one or more sets of CG groups. For example, a first codepoint may correspond to the first UE behavior and a second codepoint may correspond to the second UE behavior and one of the one or more sets of CG groups.

At 515, the UE 115-b may transmit, to the network entity 105-b, an uplink control message including an indicator which indicates the first UE behavior or the second UE behavior. For example, the indicator may include the first codepoint or the second codepoint. In some examples, the uplink control message may be a MAC-CE. In some examples, the uplink control message may be a UCI. The indicator may include one or more bits indicating the first component carrier or the second component carrier (e.g., corresponding to the second CG group and the first CG group, respectively) for the UE 115-b to use for uplink transmissions. For example, as described in greater detail with reference to FIG. 4, the indicator may include a multi-bit (e.g., four bit) chokepoint indicating one of multiple behaviors (e.g., four behaviors) including CG skipping for a duration, or CG group switching).

In some examples, the RRC signaling (e.g., at 505) may enable CG skipping (e.g., but not CG group switching). In such examples, a one bit indicator (e.g., UCI or MAC-CE) may indicate one skipping duration or one quantity of CG occasions (e.g., indicating an RRC configured duration) is being skipped. If the indicator is a multi-bit indicator (e.g., a two bit indicator), then the UE may indicate one of multiple (e.g., up to four) possible durations (e.g., from a set of RRC configured durations) is being skipped. A skipping duration may be mapped to a quantity of CG occasions, and the skipping can be assumed to be the CG occasion that occurs right after the UCI is received (e.g., the next CG occasion is being skipped). An application delay may also be implemented, where the CG skipping may begin after the delay is applied (e.g., the next CG occasion after the delay is applied is being skipped). In some examples, such an application delay may be defined by a quantity of CG occasions or CGs after the UCI message (e.g., the indicator) is received. For example, the application delay may be equal to a number X of configured grant occasions after UCI is received, where X is a positive integer.

In some examples, at 520, the UE 115-b may switch CG groups according to the second UE behavior. For example, the UE 115-b may switch to the second CG group and may transmit and receive signaling according to the second CG group. The UE 115-b may additionally skip the first CG group (e.g., refrain from transmitting and receiving signaling in one or more CG occasions according to the first CG group).

At 525, the UE 115-b may transmit uplink signaling to the network entity 105-b. For example, the UE 115-b may transmit uplink signaling according to the first UE behavior or the second UE behavior. That is, in some examples (e.g., if the indication in the uplink control message indicates the first UE behavior), the UE 115-b may transmit uplink signaling (e.g., one or more control messages, one or more data messages, or both) during one or more CG occasions and may refrain from transmitting during one or more CG occasions. In some examples (e.g., if the indication in the uplink control message indicates the second UE behavior), the UE 115-b may transmit uplink signaling during one or more CG occasions corresponding to the second CG group and may refrain from transmitting during one or more CG occasions corresponding to the first CG group.

In some examples, at 530, the UE 115-b may switch CG groups. For example, if the first CG group is a default CG group, the UE 115-b may switch from the second CG group to the first CG group upon expiration of the timer. The UE 115-b may communicate with the network entity 105-b according to the first CG group.

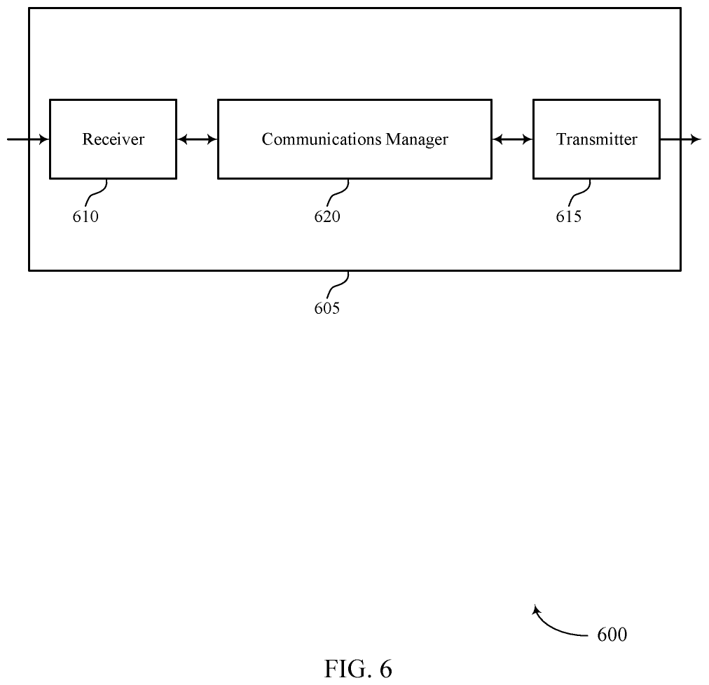

FIG. 6 shows a block diagram 600 of a device 605 that supports uplink control signaling indicating CG group switching and CG skipping in accordance with one or more aspects of the present disclosure. The device 605 may be an example of aspects of a UE 115 as described herein. The device 605 may include a receiver 610, a transmitter 615, and a communications manager 620. The device 605 may also include one or more processors, memory coupled with the one or more processors, and instructions stored in the memory that are executable by the one or more processors to enable the one or more processors to perform the CG skipping and CG group switching indication features discussed herein. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink control signaling indicating CG group switching and CG skipping). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink control signaling indicating CG group switching and CG skipping). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of uplink control signaling indicating CG group switching and CG skipping as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 is capable of, configured to, or operable to support a means for transmitting an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second configured grant group. The communications manager 620 is capable of, configured to, or operable to support a means for transmitting uplink signaling via one or more CG occasions in accordance with the indicator.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for CG occasions skipping and CG group switching resulting in more efficient utilization of communication resources, and decreased latency.

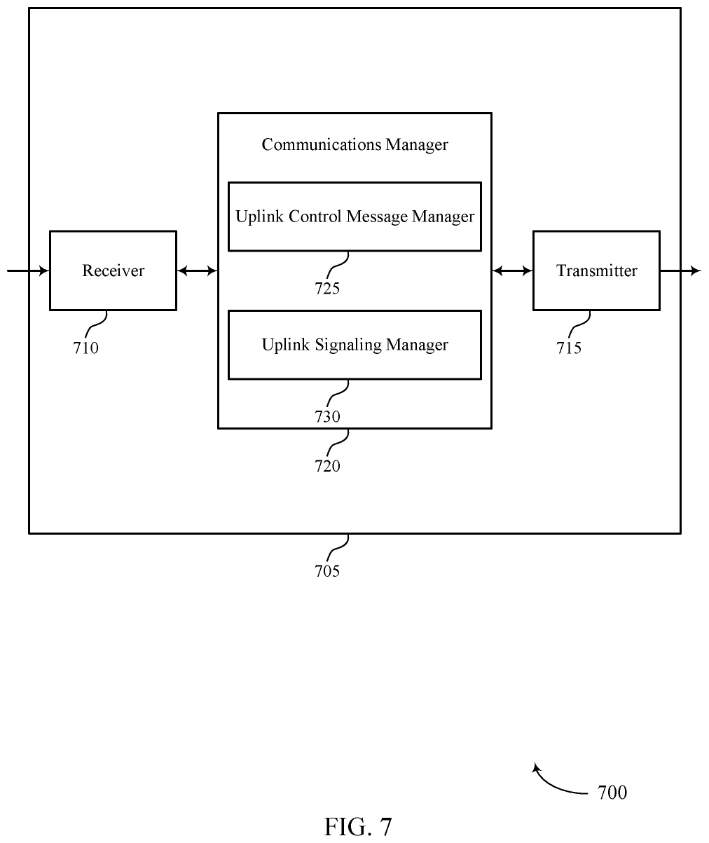

FIG. 7 shows a block diagram 700 of a device 705 that supports uplink control signaling indicating CG group switching and CG skipping in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to uplink control signaling indicating CG group switching and CG skipping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to uplink control signaling indicating CG group switching and CG skipping). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of uplink control signaling indicating CG group switching and CG skipping as described herein. For example, the communications manager 720 may include an Uplink Control Message Manager 725 an Uplink Signaling Manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The Uplink Control Message Manager 725 is capable of, configured to, or operable to support a means for transmitting an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second configured grant group. The Uplink Signaling Manager 730 is capable of, configured to, or operable to support a means for transmitting uplink signaling via one or more CG occasions in accordance with the indicator.

In some cases, the uplink control message manager 725 and the uplink signaling manager 730 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the uplink control message manager 725 and the uplink signaling manager 730 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

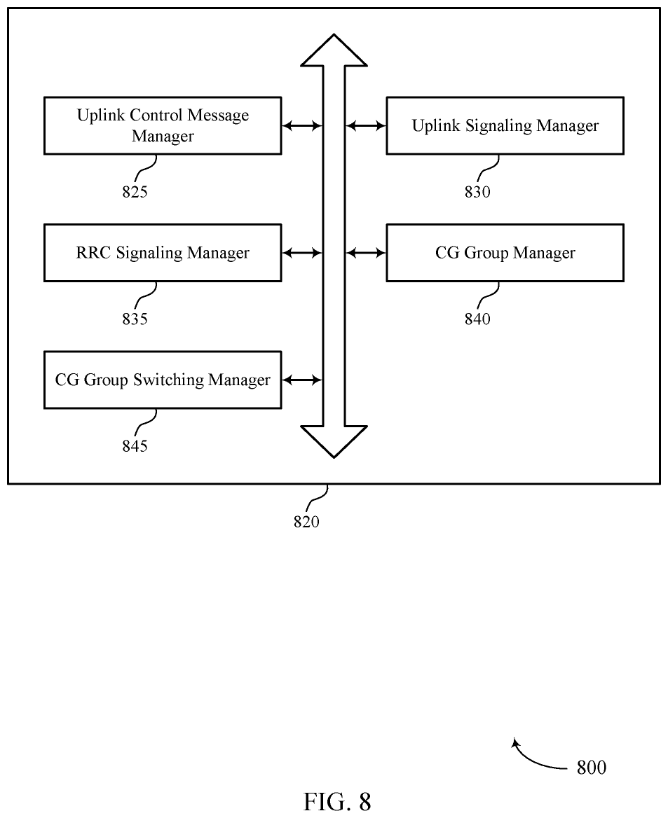

FIG. 8 shows a block diagram 800 of a communications manager 820 that supports uplink control signaling indicating CG group switching and CG skipping in accordance with one or more aspects of the present disclosure. The communications manager 820 may be an example of aspects of a communications manager 620, a communications manager 720, or both, as described herein. The communications manager 820, or various components thereof, may be an example of means for performing various aspects of uplink control signaling indicating CG group switching and CG skipping as described herein. For example, the communications manager 820 may include an Uplink Control Message Manager 825, an Uplink Signaling Manager 830, an RRC Signaling Manager 835, a CG Group Manager 840, a CG Group Switching Manager 845, or any combination thereof. Each of these components may communicate, directly or indirectly, with one another (e.g., via one or more buses).

The communications manager 820 may support wireless communications at a UE in accordance with examples as disclosed herein. The Uplink Control Message Manager 825 is capable of, configured to, or operable to support a means for transmitting an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second configured grant group. The Uplink Signaling Manager 830 is capable of, configured to, or operable to support a means for transmitting uplink signaling via one or more CG occasions in accordance with the indicator.

In some examples, the RRC Signaling Manager 835 is capable of, configured to, or operable to support a means for receiving radio resource control signaling enabling the CG skipping, the CG group switching, or both, where transmitting the uplink control message including the indicator is based on receiving the radio resource control signaling enabling the CG skipping, the CG group switching, or both.

In some examples, to support transmitting the uplink signaling, the Uplink Signaling Manager 830 is capable of, configured to, or operable to support a means for transmitting the uplink signaling via the one or more CG occasions of the second CG group, where the indicator corresponds to the second behavior.

In some examples, to support transmitting the uplink signaling, the Uplink Signaling Manager 830 is capable of, configured to, or operable to support a means for transmitting the uplink signaling via the one or more CG occasions after skipping one or more previous CG occasions of the first CG group, where the indicator corresponds to the first behavior.

In some examples, the CG Group Manager 840 is capable of, configured to, or operable to support a means for receiving control signaling indicating that the first CG group includes a default CG group. In some examples, the CG Group Switching Manager 845 is capable of, configured to, or operable to support a means for switching, according to the second behavior, from the first CG group to the second CG group, where transmitting the uplink signaling includes transmitting the uplink signaling via the one or more CG occasions of the second CG group. In some examples, the CG Group Switching Manager 845 is capable of, configured to, or operable to support a means for switching, according to the control signaling indicating that the first CG group includes the default CG group, to the first CG group from the second CG group, upon expiration of a timer.

In some examples, the CG Group Manager 840 is capable of, configured to, or operable to support a means for receiving control signaling including an indication of the timer, where switching to the first CG group from the second CG group upon expiration of the timer is based on the indication of the timer.

In some examples, the CG Group Manager 840 is capable of, configured to, or operable to support a means for receiving, via control signaling, an indication of a set of multiple sets of CG groups, where each set of CG groups includes one or more CG groups for transmitting uplink signaling and one or more CG groups for skipping.

In some examples, each codepoint of a set of multiple codepoints of the indicator corresponds to a respective behavior of the set of multiple behaviors, a first codepoint corresponding to the first behavior, and a second codepoint corresponding to the second behavior and a first set of CG groups of the set of multiple sets of CG groups.

In some examples, to support transmitting the uplink control message, the Uplink Control Message Manager 825 is capable of, configured to, or operable to support a means for transmitting, via the indicator corresponding to the second behavior, one or more bits indicating a first component carrier corresponding to the second CG group, where the first CG group corresponds to a second component carrier.

In some examples, the uplink control message includes an uplink control information message.

In some examples, the uplink control message includes a MAC control element (CE) or uplink control information (UCI).

In some cases, the uplink control message manager 825, the uplink signaling manager 830, the RRC signaling manager 835, the CG group manager 840, and the CG group switching manager 845 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the uplink control message manager 825, the uplink signaling manager 830, the RRC signaling manager 835, the CG group manager 840, and the CG group switching manager 845 discussed herein.

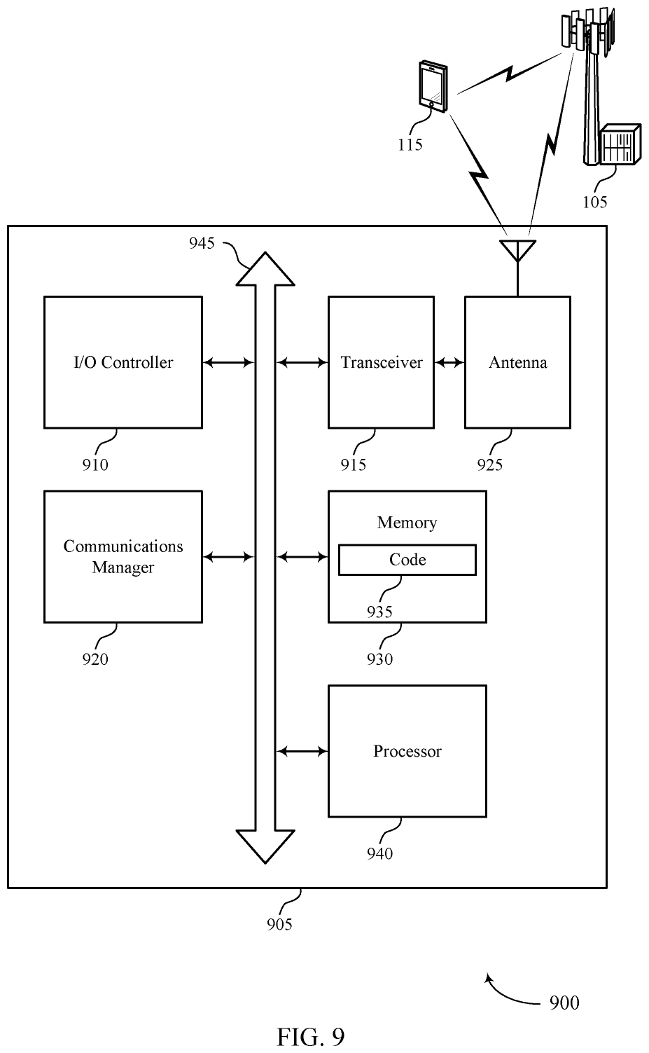

FIG. 9 shows a diagram of a system 900 including a device 905 that supports uplink control signaling indicating CG group switching and CG skipping in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting uplink control signaling indicating CG group switching and CG skipping). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 is capable of, configured to, or operable to support a means for transmitting an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second configured grant group. The communications manager 920 is capable of, configured to, or operable to support a means for transmitting uplink signaling via one or more CG occasions in accordance with the indicator.

By including or configuring the communications manager 920 in accordance with examples as described herein, the device 905 may support techniques for CG occasions skipping and CG group switching resulting in more efficient utilization of communication resources, improved coordination between devices, decreased signaling overhead, improved utilization of processing capability, decreased latency, and improved user experience.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of uplink control signaling indicating CG group switching and CG skipping as described herein, or the processor 940 and the memory 930 may be otherwise configured to perform or support such operations.

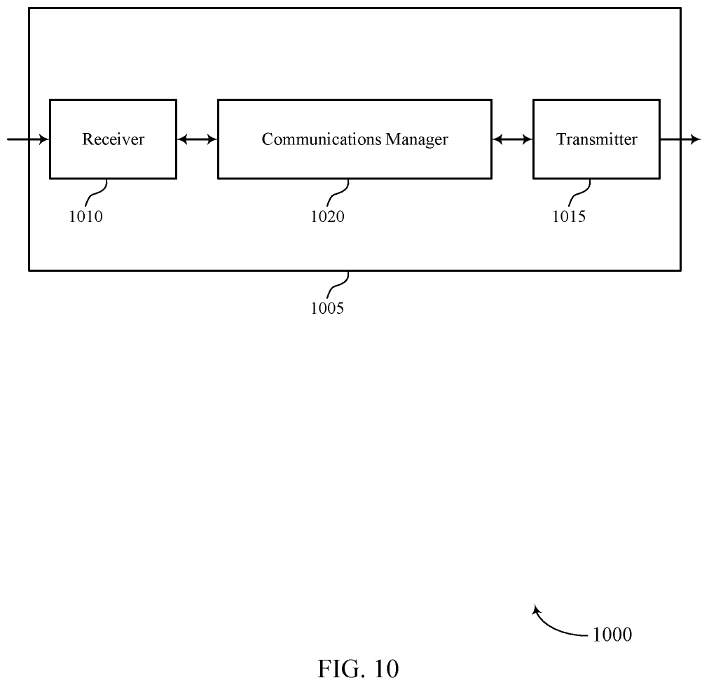

FIG. 10 shows a block diagram 1000 of a device 1005 that supports uplink control signaling indicating CG group switching and CG skipping in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include one or more processors, memory coupled with the one or more processors, and instructions stored in the memory that are executable by the one or more processors to enable the one or more processors to perform the CG skipping and CG group switching indication features discussed herein. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of uplink control signaling indicating CG group switching and CG skipping as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 is capable of, configured to, or operable to support a means for receiving an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second CG group. The communications manager 1020 is capable of, configured to, or operable to support a means for receiving uplink signaling via one or more CG occasions in accordance with the indicator.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for CG occasions skipping and CG group switching resulting in more efficient utilization of communication resources, and decreased latency.

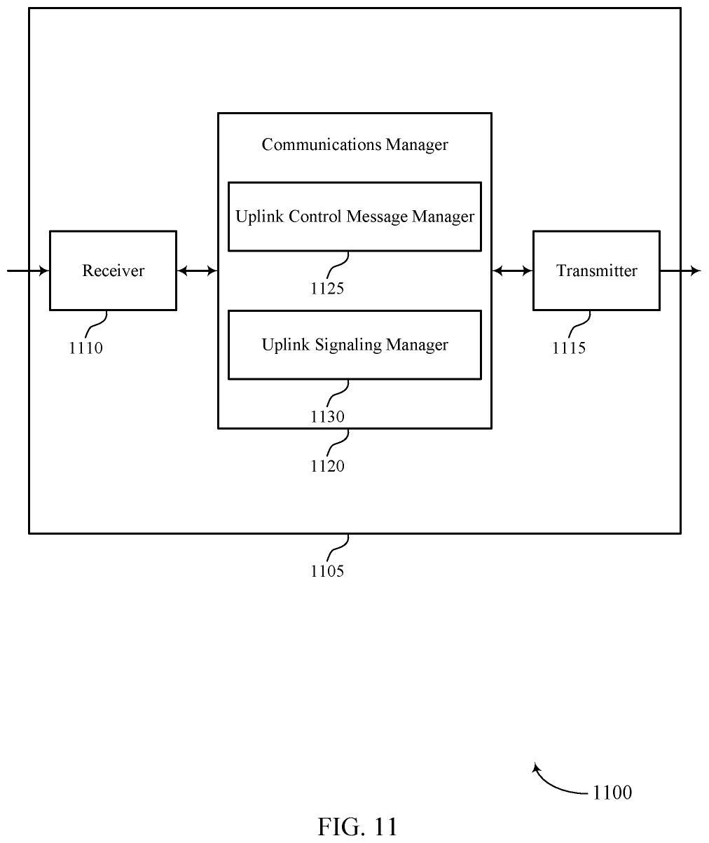

FIG. 11 shows a block diagram 1100 of a device 1105 that supports uplink control signaling indicating CG group switching and CG skipping in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of uplink control signaling indicating CG group switching and CG skipping as described herein. For example, the communications manager 1120 may include an Uplink Control Message Manager 1125 an Uplink Signaling Manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The Uplink Control Message Manager 1125 is capable of, configured to, or operable to support a means for receiving an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second CG group. The Uplink Signaling Manager 1130 is capable of, configured to, or operable to support a means for receiving uplink signaling via one or more CG occasions in accordance with the indicator.

In some cases, the uplink control message manager 1125 and the uplink signaling manager 1130 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the uplink control message manager 1125 and the uplink signaling manager 1130 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

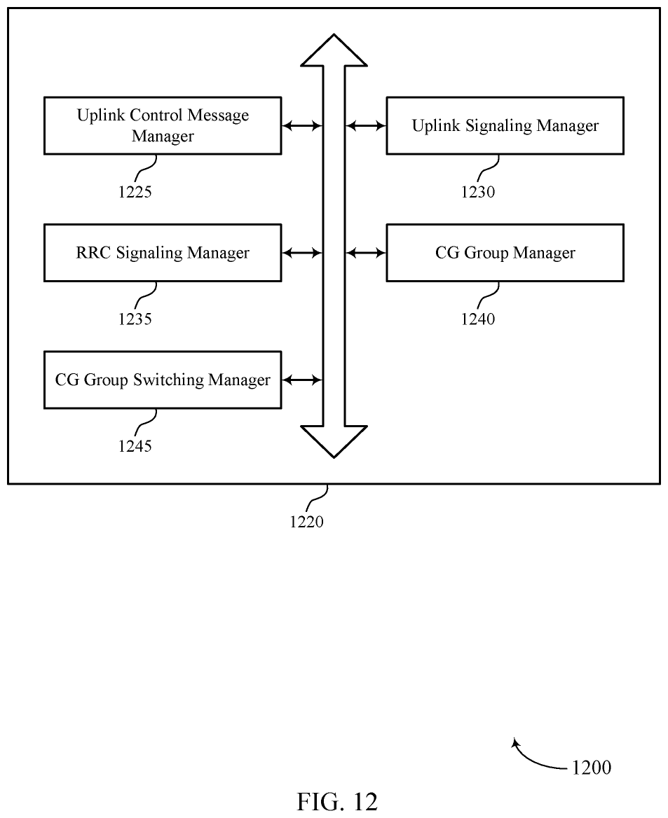

FIG. 12 shows a block diagram 1200 of a communications manager 1220 that supports uplink control signaling indicating CG group switching and CG skipping in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of uplink control signaling indicating CG group switching and CG skipping as described herein. For example, the communications manager 1220 may include an Uplink Control Message Manager 1225, an Uplink Signaling Manager 1230, an RRC Signaling Manager 1235, a CG Group Manager 1240, a CG Group Switching Manager 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The Uplink Control Message Manager 1225 is capable of, configured to, or operable to support a means for receiving an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second CG group. The Uplink Signaling Manager 1230 is capable of, configured to, or operable to support a means for receiving uplink signaling via one or more CG occasions in accordance with the indicator.

In some examples, the RRC Signaling Manager 1235 is capable of, configured to, or operable to support a means for transmitting radio resource control signaling enabling CG skipping, CG group switching, or both, where receiving the uplink control message including the indicator is based on transmitting the radio resource control signaling enabling CG skipping, CG group switching, or both.

In some examples, to support receiving the uplink signaling, the Uplink Signaling Manager 1230 is capable of, configured to, or operable to support a means for receiving the uplink signaling via the one or more CG occasions of the second CG group, where the indicator corresponds to the second behavior.

In some examples, to support receiving the uplink signaling, the Uplink Signaling Manager 1230 is capable of, configured to, or operable to support a means for receiving the uplink signaling via the one or more CG occasions after skipping one or more previous CG occasions of the first CG group, where the indicator corresponds to the first behavior.

In some examples, the CG Group Manager 1240 is capable of, configured to, or operable to support a means for transmitting control signaling indicating that the first CG group includes a default CG group. In some examples, the CG Group Switching Manager 1245 is capable of, configured to, or operable to support a means for switching, according to the second behavior, from the first CG group to the second CG group, where receiving the uplink signaling includes receiving the uplink signaling via the one or more CG occasions of the second CG group. In some examples, the CG Group Switching Manager 1245 is capable of, configured to, or operable to support a means for switching, according to the control signaling indicating that the first CG group includes the default CG group, to the first CG group from the second CG group, upon expiration of a timer.

In some examples, the CG Group Manager 1240 is capable of, configured to, or operable to support a means for transmitting control signaling including an indication of the timer, where switching to the first CG group from the second CG group upon expiration of the timer is based on the indication of the timer.

In some examples, the CG Group Manager 1240 is capable of, configured to, or operable to support a means for transmitting, via control signaling, an indication of a set of multiple sets of CG groups, where each set of CG groups includes one or more CG groups for transmitting uplink signaling and one or more CG groups for skipping.

In some examples, each codepoint of a set of multiple codepoints of the indicator corresponds to a respective behavior of the set of multiple behaviors, a first codepoint corresponding to the first behavior, and a second codepoint corresponding to the second behavior and a first set of CG groups of the set of multiple sets of CG groups.

In some examples, to support receiving the uplink control message, the Uplink Control Message Manager 1225 is capable of, configured to, or operable to support a means for receiving, via the indicator corresponding to the second behavior, one or more bits indicating a first component carrier corresponding to the second CG group, where the first CG group corresponds to a second component carrier.

In some examples, the uplink control message includes an uplink control information message.

In some examples, the uplink control message includes a MAC control element (CE) or uplink control information (UCI).

In some cases, the uplink control message manager 1225, the uplink signaling manager 1230, the RRC signaling manager 1235, the CG group manager 1240, and the CG group switching manager 1245 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the uplink control message manager 1225, the uplink signaling manager 1230, the RRC signaling manager 1235, the CG group manager 1240, and the CG group switching manager 1245 discussed herein.

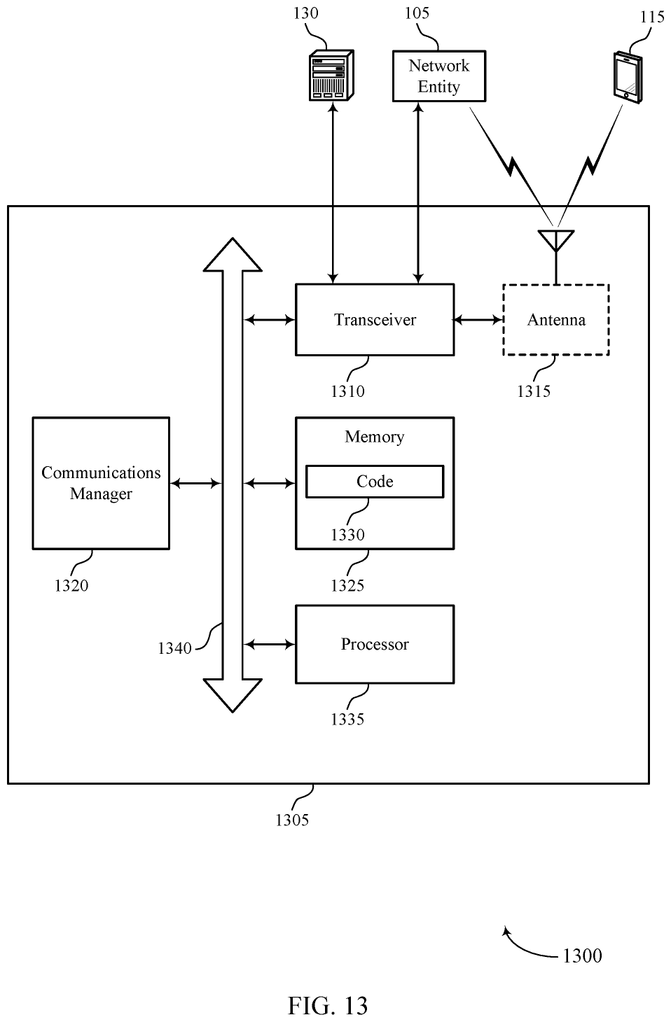

FIG. 13 shows a diagram of a system 1300 including a device 1305 that supports uplink control signaling indicating CG group switching and CG skipping in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting uplink control signaling indicating CG group switching and CG skipping). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 is capable of, configured to, or operable to support a means for receiving an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second CG group. The communications manager 1320 is capable of, configured to, or operable to support a means for receiving uplink signaling via one or more CG occasions in accordance with the indicator.

By including or configuring the communications manager 1320 in accordance with examples as described herein, the device 1305 may support techniques for CG occasions skipping and CG group switching resulting in more efficient utilization of communication resources, improved coordination between devices, decreased signaling overhead, decreased system latency, improved utilization of processing capability, and improved user experience.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of uplink control signaling indicating CG group switching and CG skipping as described herein, or the processor 1335 and the memory 1325 may be otherwise configured to perform or support such operations.

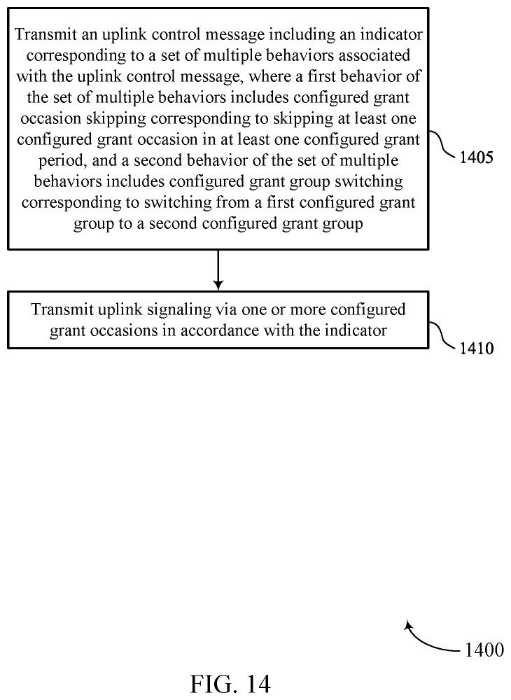

FIG. 14 shows a flowchart illustrating a method 1400 that supports uplink control signaling indicating CG group switching and CG skipping in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1405, the method may include transmitting an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second configured grant group. The operations of 1405 may be performed in accordance with examples as disclosed herein. In some examples, aspects of the operations of 1405 may be performed by an Uplink Control Message Manager 825 as described with reference to FIG. 8.

At 1410, the method may include transmitting uplink signaling via one or more CG occasions in accordance with the indicator. The operations of 1410 may be performed in accordance with examples as disclosed herein. In some examples, aspects of the operations of 1410 may be performed by an Uplink Signaling Manager 830 as described with reference to FIG. 8.

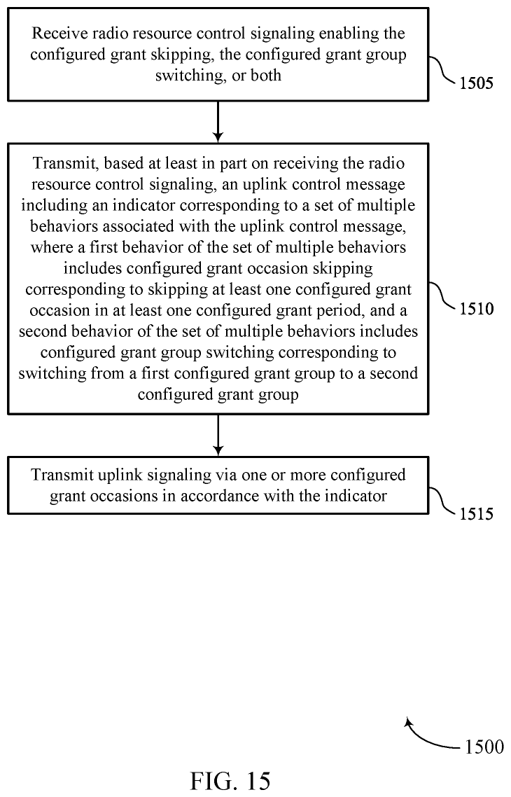

FIG. 15 shows a flowchart illustrating a method 1500 that supports uplink control signaling indicating CG group switching and CG skipping in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving radio resource control signaling enabling CG skipping, CG group switching, or both, where transmitting the uplink control message including the indicator is based on receiving the radio resource control signaling enabling the CG skipping, the CG group switching, or both. The operations of 1505 may be performed in accordance with examples as disclosed herein. In some examples, aspects of the operations of 1505 may be performed by an RRC Signaling Manager 835 as described with reference to FIG. 8.

At 1510, the method may include transmitting, based at least in part on receiving the control signaling, an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second CG group. The operations of 1510 may be performed in accordance with examples as disclosed herein. In some examples, aspects of the operations of 1510 may be performed by an Uplink Control Message Manager 825 as described with reference to FIG. 8.

At 1515, the method may include transmitting uplink signaling via one or more CG occasions in accordance with the indicator. The operations of 1515 may be performed in accordance with examples as disclosed herein. In some examples, aspects of the operations of 1515 may be performed by an Uplink Signaling Manager 830 as described with reference to FIG. 8.

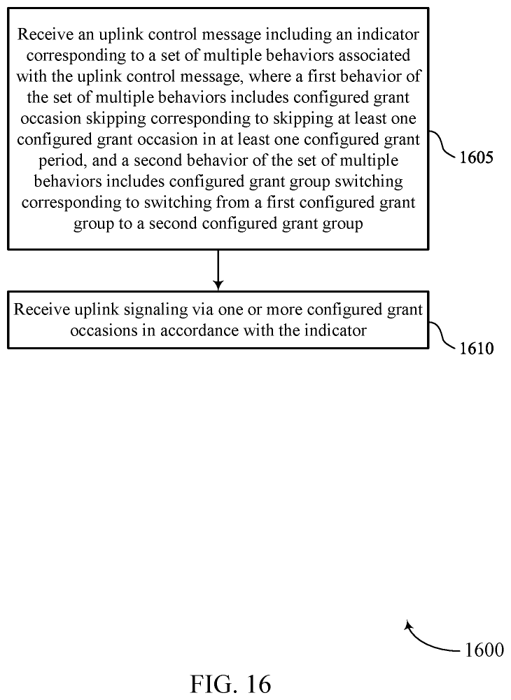

FIG. 16 shows a flowchart illustrating a method 1600 that supports uplink control signaling indicating CG group switching and CG skipping in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1605, the method may include receiving an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second CG group. The operations of 1605 may be performed in accordance with examples as disclosed herein. In some examples, aspects of the operations of 1605 may be performed by an Uplink Control Message Manager 1225 as described with reference to FIG. 12.

At 1610, the method may include receiving uplink signaling via one or more CG occasions in accordance with the indicator. The operations of 1610 may be performed in accordance with examples as disclosed herein. In some examples, aspects of the operations of 1610 may be performed by an Uplink Signaling Manager 1230 as described with reference to FIG. 12.

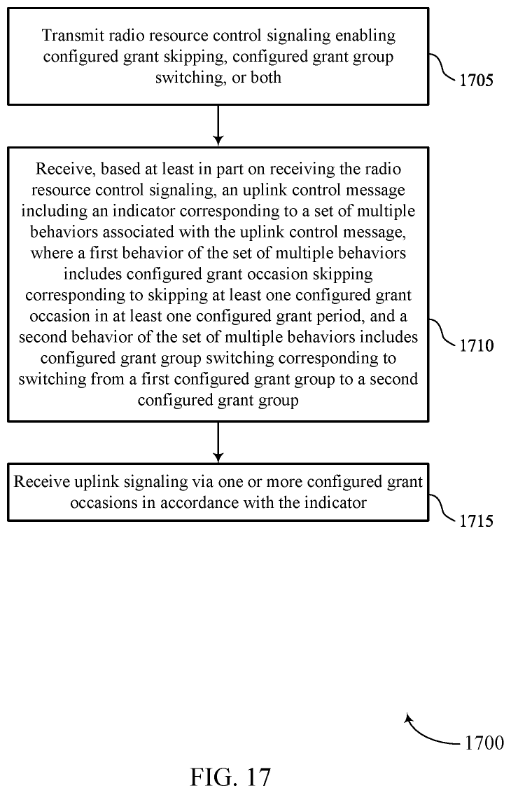

FIG. 17 shows a flowchart illustrating a method 1700 that supports uplink control signaling indicating CG group switching and CG skipping in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include transmitting radio resource control signaling enabling CG skipping, CG group switching, or both, where receiving the uplink control message including the indicator is based on transmitting the radio resource control signaling enabling CG skipping, CG group switching, or both. The operations of 1705 may be performed in accordance with examples as disclosed herein. In some examples, aspects of the operations of 1705 may be performed by an RRC Signaling Manager 1235 as described with reference to FIG. 12.

At 1710, the method may include receiving, based at least in part on transmitting the radio resource control signaling, an uplink control message including an indicator corresponding to a set of multiple behaviors associated with the uplink control message, where a first behavior of the set of multiple behaviors includes CG occasion skipping corresponding to skipping at least one CG occasion in at least one CG period, and a second behavior of the set of multiple behaviors includes CG group switching corresponding to switching from a first CG group to a second CG group. The operations of 1710 may be performed in accordance with examples as disclosed herein. In some examples, aspects of the operations of 1710 may be performed by an Uplink Control Message Manager 1225 as described with reference to FIG. 12.

At 1715, the method may include receiving uplink signaling via one or more CG occasions in accordance with the indicator. The operations of 1715 may be performed in accordance with examples as disclosed herein. In some examples, aspects of the operations of 1715 may be performed by an Uplink Signaling Manager 1230 as described with reference to FIG. 12.

The following provides an overview of aspects of the present disclosure:

Aspect 1: A method for wireless communications at a UE, comprising: transmitting an uplink control message comprising an indicator corresponding to a plurality of behaviors associated with the uplink control message, wherein a first behavior of the plurality of behaviors comprises configured grant occasion skipping corresponding to skipping at least one configured grant occasion in at least one configured grant period, and a second behavior of the plurality of behaviors comprises configured grant group switching corresponding to switching from a first configured grant group to a second configured grant group; and transmitting uplink signaling via one or more configured grant occasions in accordance with the indicator.

Aspect 2: The method of aspect 1, further comprising: receiving radio resource control signaling enabling the configured grant occasion skipping, the configured grant group switching, or both, wherein transmitting the uplink control message comprising the indicator is based at least in part on receiving the radio resource control signaling enabling the configured grant occasion skipping, the configured grant group switching, or both.

Aspect 3: The method of any of aspects 1 through 2, wherein transmitting the uplink signaling comprises: transmitting the uplink signaling via the one or more configured grant occasions of the second configured grant group, wherein the indicator corresponds to the second behavior.

Aspect 4: The method of any of aspects 1 through 2, wherein transmitting the uplink signaling comprises: transmitting the uplink signaling via the one or more configured grant occasions after skipping one or more previous configured grant occasions of the first configured grant group, wherein the indicator corresponds to the first behavior.

Aspect 5: The method of any of aspects 1 through 3, further comprising: receiving control signaling indicating that the first configured grant group comprises a default configured grant group; switching, according to the second behavior, from the first configured grant group to the second configured grant group, wherein transmitting the uplink signaling comprises transmitting the uplink signaling via the one or more configured grant occasions of the second configured grant group; and switching, according to the control signaling indicating that the first configured grant group comprises the default configured grant group, to the first configured grant group from the second configured grant group, upon expiration of a timer.

Aspect 6: The method of aspect 5, further comprising: receiving control signaling comprising an indication of the timer, wherein switching to the first configured grant group from the second configured grant group upon expiration of the timer is based at least in part on the indication of the timer.

Aspect 7: The method of any of aspects 1 through 6, further comprising: receiving, via control signaling, an indication of a plurality of sets of configured grant groups, wherein each set of configured grant groups comprises one or more configured grant groups for transmitting uplink signaling and one or more configured grant groups for skipping.

Aspect 8: A method for wireless communications at a network entity, comprising: receiving an uplink control message comprising an indicator corresponding to a plurality of behaviors associated with the uplink control message, wherein a first behavior of the plurality of behaviors comprises configured grant occasion skipping corresponding to skipping at least one configured grant occasion in at least one configured grant period, and a second behavior of the plurality of behaviors comprises configured grant group switching corresponding to switching from a first configured grant group to a second configured grant group; and receiving uplink signaling via one or more configured grant occasions in accordance with the indicator.

Aspect 9: An apparatus for wireless communications at a UE, comprising a processor; memory coupled with the processor; and instructions stored in the memory and executable by the processor to cause the apparatus to perform a method of any of aspects 1 through 7.

Aspect 10: An apparatus for wireless communications at a UE, comprising at least one means for performing a method of any of aspects 1 through 7.

Aspect 11: A non-transitory computer-readable medium storing code for wireless communications at a UE, the code comprising instructions executable by a processor to perform a method of any of aspects 1 through 7.

Aspect 12: An apparatus for wireless communications at a network entity, comprising a processor; memory coupled with the processor; and instructions stored in the memory and executable by the processor to cause the apparatus to perform the method of aspect 8.

Aspect 13: An apparatus for wireless communications at a network entity, comprising at least one means for performing the method aspect 8.

Aspect 14: A non-transitory computer-readable medium storing code for wireless communications at a network entity, the code comprising instructions executable by a processor to perform the method of aspect 8.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
transmit an uplink control message comprising an indicator corresponding to a plurality of behaviors associated with the uplink control message, wherein a first behavior of the plurality of behaviors comprises configured grant occasion skipping corresponding to skipping at least one configured grant occasion in at least one configured grant period, and a second behavior of the plurality of behaviors comprises configured grant group switching corresponding to switching from a first configured grant group to a second configured grant group; and
transmit uplink signaling via one or more configured grant occasions in accordance with the indicator.

2. The apparatus of claim 1, wherein the instructions are further executable by the processor to cause the apparatus to:
receive radio resource control signaling enabling the configured grant occasion skipping, the configured grant group switching, or both, wherein the uplink control message comprising the indicator is transmitted based at least in part on receipt of the radio resource control signaling enabling the configured grant occasion skipping, the configured grant group switching, or both.

3. The apparatus of claim 1, wherein the instructions are further executable by the processor to transmit the uplink signaling by being executable to cause the processor to:
transmit the uplink signaling via the one or more configured grant occasions of the second configured grant group, wherein the indicator corresponds to the second behavior.

4. The apparatus of claim 1, wherein the instructions are further executable by the processor to transmit the uplink signaling by being executable to cause the processor to:
transmit the uplink signaling via the one or more configured grant occasions after skipping one or more previous configured grant occasions of the first configured grant group, wherein the indicator corresponds to the first behavior.

5. The apparatus of claim 1, wherein the instructions are further executable by the processor to cause the apparatus to:
receive control signaling indicating that the first configured grant group comprises a default configured grant group;
switch, according to the second behavior, from the first configured grant group to the second configured grant group, wherein the uplink signaling is transmitted via the one or more configured grant occasions of the second configured grant group; and
switch, according to the control signaling indicating that the first configured grant group comprises the default configured grant group, to the first configured grant group from the second configured grant group, upon expiration of a timer.

6. The apparatus of claim 5, wherein the instructions are further executable by the processor to cause the apparatus to:
receive control signaling comprising an indication of the timer, wherein the instructions are executable by the processor to switch to the first configured grant group from the second configured grant group upon expiration of the timer based at least in part on the indication of the timer.

7. The apparatus of claim 1, wherein the instructions are further executable by the processor to cause the apparatus to:
receive, via control signaling, an indication of a plurality of sets of configured grant groups, wherein each set of configured grant groups comprises one or more configured grant groups for transmitting uplink signaling and one or more configured grant groups for skipping.

8. The apparatus of claim 7, wherein each codepoint of a plurality of codepoints of the indicator corresponds to a respective behavior of the plurality of behaviors, a first codepoint corresponding to the first behavior, and a second codepoint corresponding to the second behavior and a first set of configured grant groups of the plurality of sets of configured grant groups.

9. The apparatus of claim 1, wherein the instructions are further executable by the processor to transmit the uplink control message by being executable to cause the processor to:
transmit, via the indicator corresponding to the second behavior, one or more bits indicating a first component carrier corresponding to the second configured grant group, wherein the first configured grant group corresponds to a second component carrier.

10. The apparatus of claim 1, wherein the uplink control message comprises an uplink control information message.

11. The apparatus of claim 1, wherein the uplink control message comprises a media access control (MAC) control element (CE) or uplink control information (UCI).

12. An apparatus for wireless communications at a network entity, comprising:
a processor;
memory coupled with the processor; and
instructions stored in the memory and executable by the processor to cause the apparatus to:
receive an uplink control message comprising an indicator corresponding to a plurality of behaviors associated with the uplink control message, wherein a first behavior of the plurality of behaviors comprises configured grant occasion skipping corresponding to skipping at least one configured grant occasion in at least one configured grant period, and a second behavior of the plurality of behaviors comprises configured grant group switching corresponding to switching from a first configured grant group to a second configured grant group; and
receive uplink signaling via one or more configured grant occasions in accordance with the indicator.

13. The apparatus of claim 12, wherein the instructions are further executable by the processor to cause the apparatus to:
transmit radio resource control signaling enabling configured grant occasion skipping, configured grant group switching, or both, wherein the uplink control message comprising the indicator is received based at least in part on transmission of the radio resource control signaling enabling configured grant occasion skipping, configured grant group switching, or both.

14. The apparatus of claim 12, wherein the instructions are further executable by the processor to receive the uplink signaling by being executable to cause the processor to:
receive the uplink signaling via the one or more configured grant occasions of the second configured grant group, wherein the indicator corresponds to the second behavior.

15. The apparatus of claim 12, wherein the instructions are further executable by the processor to receive the uplink signaling by being executable to cause the processor to:
receive the uplink signaling via the one or more configured grant occasions after skipping one or more previous configured grant occasions of the first configured grant group, wherein the indicator corresponds to the first behavior.

16. The apparatus of claim 12, wherein the instructions are further executable by the processor to cause the apparatus to:
transmit control signaling indicating that the first configured grant group comprises a default configured grant group;
switch, according to the second behavior, from the first configured grant group to the second configured grant group, wherein the uplink signaling is received via the one or more configured grant occasions of the second configured grant group; and
switch, according to the control signaling indicating that the first configured grant group comprises the default configured grant group, to the first configured grant group from the second configured grant group, upon expiration of a timer.

17. The apparatus of claim 16, wherein the instructions are further executable by the processor to cause the apparatus to:
transmit control signaling comprising an indication of the timer, wherein the instructions are further executable by the processor to switch to the first configured grant group from the second configured grant group upon expiration of the timer based at least in part on the indication of the timer.

18. The apparatus of claim 12, wherein the instructions are further executable by the processor to cause the apparatus to:
transmit, via control signaling, an indication of a plurality of sets of configured grant groups, wherein each set of configured grant groups comprises one or more configured grant groups for transmitting uplink signaling and one or more configured grant groups for skipping.

19. The apparatus of claim 18, wherein each codepoint of a plurality of codepoints of the indicator corresponds to a respective behavior of the plurality of behaviors, a first codepoint corresponding to the first behavior, and a second codepoint corresponding to the second behavior and a first set of configured grant groups of the plurality of sets of configured grant groups.

20. The apparatus of claim 12, wherein the instructions are further executable by the processor to receive the uplink control message by being executable to cause the processor to:
receive, via the indicator corresponding to the second behavior, one or more bits indicating a first component carrier corresponding to the second configured grant group, wherein the first configured grant group corresponds to a second component carrier.

21. The apparatus of claim 12, wherein the uplink control message comprises an uplink control information message.

22. The apparatus of claim 12, wherein the uplink control message comprises a media access control (MAC) control element (CE) or uplink control information (UCI).

23. A method for wireless communications at a user equipment (UE), comprising:
transmitting an uplink control message comprising an indicator corresponding to a plurality of behaviors associated with the uplink control message, wherein a first behavior of the plurality of behaviors comprises configured grant occasion skipping corresponding to skipping at least one configured grant occasion in at least one configured grant period, and a second behavior of the plurality of behaviors comprises configured grant group switching corresponding to switching from a first configured grant group to a second configured grant group; and
transmitting uplink signaling via one or more configured grant occasions in accordance with the indicator.

24. The method of claim 23, further comprising:
receiving radio resource control signaling enabling the configured grant occasion skipping, the configured grant group switching, or both, wherein transmitting the uplink control message comprising the indicator is based at least in part on receiving the radio resource control signaling enabling the configured grant occasion skipping, the configured grant group switching, or both.

25. The method of claim 23, wherein transmitting the uplink signaling comprises:
transmitting the uplink signaling via the one or more configured grant occasions of the second configured grant group, wherein the indicator corresponds to the second behavior.

26. The method of claim 23, wherein transmitting the uplink signaling comprises:
transmitting the uplink signaling via the one or more configured grant occasions after skipping one or more previous configured grant occasions of the first configured grant group, wherein the indicator corresponds to the first behavior.

27. The method of claim 23, further comprising:
receiving control signaling indicating that the first configured grant group comprises a default configured grant group;
switching, according to the second behavior, from the first configured grant group to the second configured grant group, wherein transmitting the uplink signaling comprises transmitting the uplink signaling via the one or more configured grant occasions of the second configured grant group; and
switching, according to the control signaling indicating that the first configured grant group comprises the default configured grant group, to the first configured grant group from the second configured grant group, upon expiration of a timer.

28. The method of claim 27, further comprising:
receiving control signaling comprising an indication of the timer, wherein switching to the first configured grant group from the second configured grant group upon expiration of the timer is based at least in part on the indication of the timer.

29. The method of claim 23, further comprising:
receiving, via control signaling, an indication of a plurality of sets of configured grant groups, wherein each set of configured grant groups comprises one or more configured grant groups for transmitting uplink signaling and one or more configured grant groups for skipping.

30. A method for wireless communications at a network entity, comprising:
receiving an uplink control message comprising an indicator corresponding to a plurality of behaviors associated with the uplink control message, wherein a first behavior of the plurality of behaviors comprises configured grant occasion skipping corresponding to skipping at least one configured grant occasion in at least one configured grant period, and a second behavior of the plurality of behaviors comprises configured grant group switching corresponding to switching from a first configured grant group to a second configured grant group; and
receiving uplink signaling via one or more configured grant occasions in accordance with the indicator.
